(19) United States
(12) Patent Application Publication
(10) Pub. No.: US 2010/0203901 A1
(43) Pub. Date: Aug. 12, 2010

(54) Location-Based Services Using Geofences Generated from Learned Patterns of Movement

(76) Inventors: Robert K. Dinoff, Bridgewater, NJ (US); Tin Kam Ho, Cedar Grove, NJ (US); Richard B. Hull, Chatham, NJ (US); Bharat Kumar, Bridgewater, NJ (US); Daniel Francis Lieuwen, Somerville, NJ (US); Hendrik B. Meeuwissen, Huizen (NL); Haobo Ren, Belle Mead, NJ (US); Paulo A. Santos, Morganville, NJ (US)

Correspondence Address: RYAN, MASON & LEWIS, LLP, 90 FOREST AVENUE, LOCUST VALLEY, NY, 11560, US

(21) Appl. No.: 12/369,319

(22) Filed: Feb. 11, 2009

(51) Int. Cl. H04W 24/00

(52) U.S. Cl. 455/456.3

(57) ABSTRACT

Location-based services are provided in a communication system comprising a wireless network. In one aspect, information indicative of location of a given mobile user device of the system is periodically collected. The collected location information is processed in a server or other processing device of the system to determine at least one normal pattern of movement of the mobile user device from at least a first location to a second location. An alert is generated if subsequent movement of the mobile user device from the first location to the second location exhibits a significant deviation from the normal pattern of movement. The normal pattern of movement may be used to generate a multidimensional geofence that includes, in addition to a geographic area dimension, at least one additional dimension such as, for example, a speed of movement dimension, a direction of movement dimension, a stop duration dimension, or a related device proximity dimension.

### FIELD OF THE INVENTION

The present invention relates generally to wireless communication systems, and more particularly to techniques for providing location-based message delivery and other services in such systems.

### BACKGROUND OF THE INVENTION

A wide variety of different types of wireless communication systems are known. For example, a typical wireless cellular network includes a multitude of interconnected base stations which communicate with mobile user devices within defined coverage areas.

Numerous techniques have been developed which deliver advertising or other types of messages to mobile user devices of a wireless communication system based on the current locations of those devices. Thus, if a given user device is determined to be in close proximity to a particular retail establishment, an advertisement or other message associated with that establishment may be delivered to the user device.

Other location-based services are designed to provide alerts to one user based on the location of the mobile device of another user. These include various tracking services that allow an alert to be sent when a particular mobile user device enters or leaves a designated area. A more specific example is a location-based child-tracking service that sends an alert to a mobile device or computer of a parent when a mobile device of his or her child enters or leaves a designated area. Another example is a friend-finder service which notifies friends when their respective devices are within close proximity of one another.

An issue that arises in providing these and other location-based services relates to determining when a given mobile user device has crossed a specified geographic boundary. The geographic boundary is also referred to herein as a “geofence” or simply a “fence.” Detection of a fence-crossing event may be used, for example, to control the delivery of a particular message to the given mobile user device, or to control the provision of other types of location-based services.

In a typical conventional system that generates alerts based on fence-crossing events, the fence simply defines a certain geographic area. For example, the fence may be specified as a radius of a circle centered at a particular location. Thus, the fence has only a single parameter or “dimension” at any given point in time, namely, its particular defined geographic area. Such fences are referred to herein as one-dimensional or unidimensional fences. Fence arrangements of this type unduly limit the flexibility of location-based services that can be provided by a given wireless communication system. For example, such arrangements can mask certain movements of a mobile user device that would likely be considered important to a particular location-based service application. These arrangements can also lead to an excessive rate of alerts that turn out to be false alarms or otherwise of questionable utility, thereby consuming system resources without providing adequate benefit to users.

Accordingly, improved techniques are needed which overcome the above-noted drawbacks associated with the use of conventional unidimensional fences.

### SUMMARY OF THE INVENTION

The present invention in one or more illustrative embodiments provides improved techniques for delivering location-based services involving mobile user devices associated with a wireless network of a communication system.

In accordance with one aspect of the invention, information indicative of location of a given mobile user device of a communication system is periodically collected. A server or other processing device of the communication system processes the collected location information to determine at least one normal pattern of movement of the mobile user device from at least a first location to a second location. An alert is generated if subsequent movement of the mobile user device from the first location to the second location exhibits a significant deviation from the normal pattern of movement.

The normal pattern of movement may be used to generate a multidimensional fence that includes, in addition to a geographic area dimension, at least one additional dimension such as, for example, a speed of movement dimension, a direction of movement dimension, a stop duration dimension, or a related device proximity dimension. The alert is generated if the subsequent movement of the mobile user device deviates from at least one dimension of the multidimensional fence.

The speed of movement dimension may comprise a parameter specifying a speed of movement of the mobile user device within a geographic area defined by the geographic area dimension.

The direction of movement dimension may comprise a parameter specifying a direction of movement of the mobile user device within a geographic area defined by the geographic area dimension.

The stop duration dimension may comprise a parameter specifying a particular duration of an expected stop at a given location within a geographic area defined by the geographic area dimension.

The related device proximity dimension may comprise a parameter specifying that the mobile user device either should or should not be in proximity to another mobile user device of the system within a geographic area defined by the geographic area dimension.

Other types of dimensions may be used in alternative embodiments to provide enhanced performance relative to conventional unidimensional fences.

A given multidimensional fence configured in accordance with the invention may be further characterized by various time indicators, such as time of day, day of week, or holiday indicators, which specify particular times for which the various dimensions of the multidimensional fence are valid.

In accordance with another aspect of the invention, the multidimensional fence once generated may be presented to a user of the mobile device, for example, via a provisioning interface of the server. The user may be permitted to at least temporarily override parameters specifying respective dimensions of the multidimensional fence such that an alert will not be generated if the significant deviation is a deviation in only one or more of the parameters that were overridden by the user.

The illustrative embodiments provide a number of significant advantages relative to conventional systems. For example, by utilizing multidimensional fences generated from a normal pattern of movement of a given mobile user device, the illustrative embodiments provide improved resolution of mobile user device movement, reduce the number of false alarms, and otherwise increase the utility of the alerts that are generated within the system. The disclosed arrangements thus facilitate the processing of fence-crossing information and conserve scarce resources of the wireless network, while also providing more flexible and better targeted location-based services.

These and other features and advantages of the present invention will become more apparent from the accompanying drawings and the following detailed description.

### BRIEF DESCRIPTION OF THE DRAWINGS

FIG. 1A is a block diagram of a communication system in an illustrative embodiment of the invention.

FIG. 1B is a block diagram of a given processing device of the FIG. 1A system.

FIGS. 2A and 2B illustrate respective stationary and moving fences in the system of FIG. 1A.

FIG. 3 is a flow diagram illustrating a process for generating alerts based on learned patterns of movement in the FIG. 1A system.

FIG. 4 shows a more detailed view of one possible implementation of a server configured to generate multidimensional fences from learned patterns of movement in the system of FIG. 1A.

### DETAILED DESCRIPTION OF THE INVENTION

The present invention will be illustrated below in conjunction with exemplary wireless communication systems and associated location-based services. It should be understood, however, that the invention is not limited to use with any particular type of wireless system or location-based service. The disclosed techniques are suitable for use with a wide variety of other systems and in providing numerous alternative services.

For example, the disclosed techniques are applicable to many different types of wireless networks, including those utilizing well-known standards such as UMTS, W-CDMA, CDMA2000, HSDPA, Long-Term Evolution (LTE), IEEE 802.11 (Wi-Fi), IEEE 802.16 (WiMax), etc. The term “wireless communication system” as used herein is intended to include these and other types of wireless networks, as well as sub-networks or other portions of such networks and combinations of multiple networks operating in accordance with potentially different standards. A given wireless communication system may also include as a component thereof one or more wired networks or portions of such wired networks.

As another example, the disclosed techniques can be implemented in many other types of communication system applications, including alternative tracking applications based on radio frequency identification (RFID) tags, infrared, ultrasound, etc.

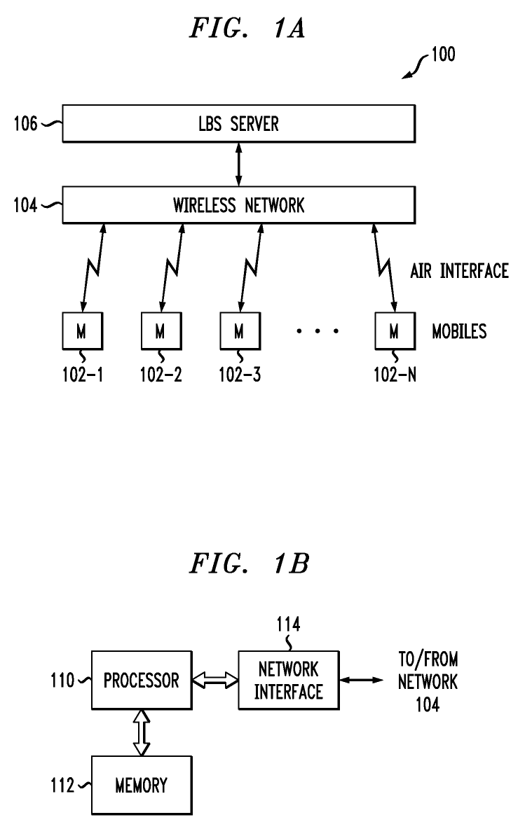

FIG. 1A shows a wireless communication system 100 in an illustrative embodiment of the invention. The communication system 100 comprises a plurality of mobile user devices 102-1, 102-2, . . . 102-N, each also being denoted M in the figure, that communicate over an air interface with a wireless network 104. The wireless network 104 has associated therewith a location-based services (LBS) server 106. Although shown as a separate element in the figure, the LBS server 106 in other embodiments may be incorporated in whole or in part into the wireless network 104.

The mobile user devices 102, which are also referred to herein as mobile devices or simply “mobiles,” may be mobile telephones, portable or laptop computers, personal digital assistants (PDAs), wireless email devices, or other portable communication devices, in any combination. The particular number N of mobile user devices 102 in the system 100 is arbitrary, and may be any desired number that can be supported by the system.

Other examples of mobile user devices in alternative embodiments may include, for example, vehicles or other moving objects that contain embedded RFID tags. The term “mobile user device” should therefore not be construed as limited to mobile telecommunications devices that communicate over a wireless network.

Each of the mobile user devices 102 is generally associated with a particular system user. However, the term “user” as utilized herein is intended to be construed broadly, and depending on the context may refer to the particular entity associated with a given mobile user device, or the mobile user device itself, or a combination of both.

The wireless network 104 may be a wireless cellular network, such as, for example, an otherwise conventional cellular network, although as indicated above a wide variety of other types of wireless networks may be used in implementing the invention. The wireless network 104 may comprise, for example, one or more base stations configured to communicate with mobile user devices 102 in a conventional manner.

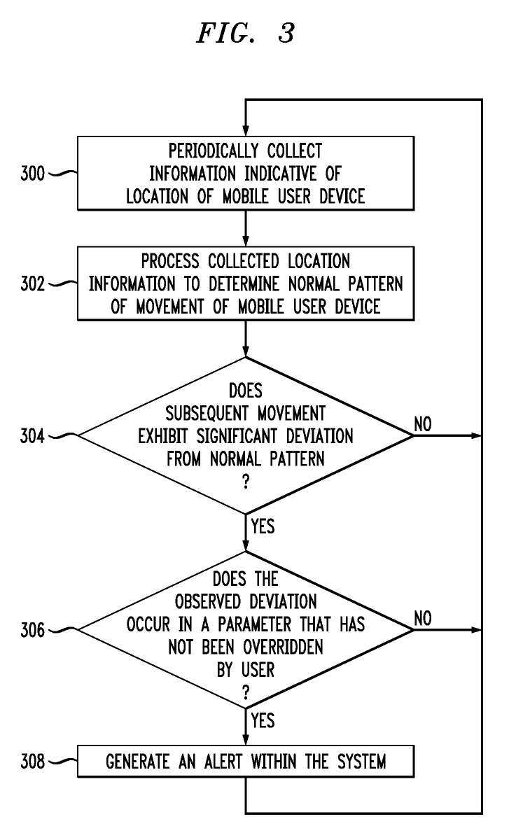

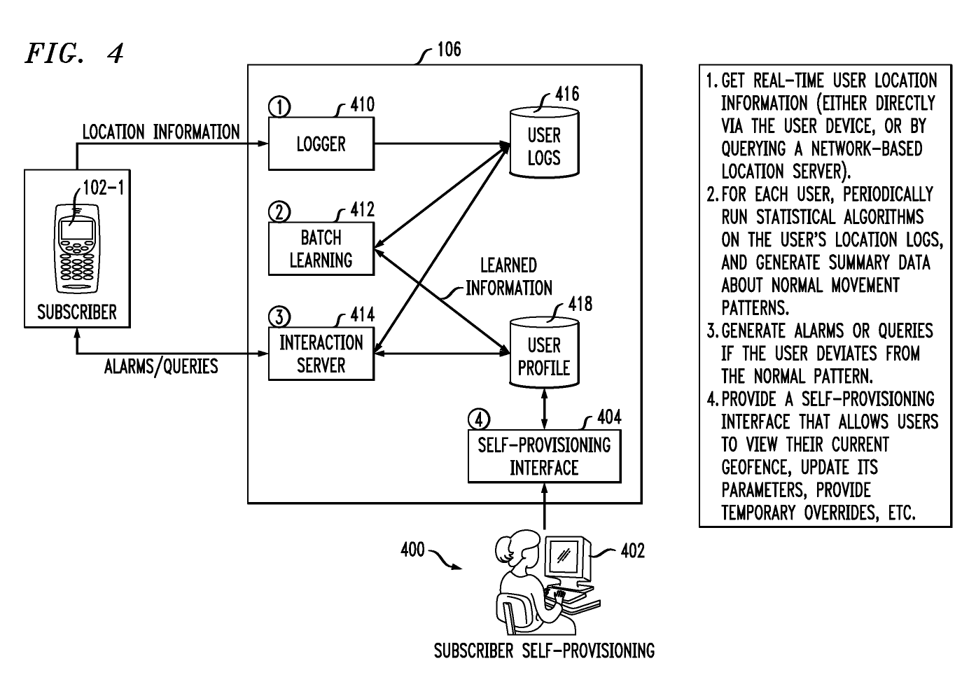

The LBS server 106 will typically comprise one or more computers or other processing devices. For example, server 106 may comprise one or more server elements of a Gcast™ system or other LBS system of the type described in U.S. Patent Application Publication No. 2007/0270133, entitled “Mobile-Initiated Location Measurement,” which is commonly assigned herewith and incorporated by reference herein. More detailed examples of the operation of LBS server 106 in the illustrative embodiments will be described below in conjunction with FIGS. 3 and 4.

Although only a single server 106 is shown in FIG. 1A, the system 100 could of course be configured to include multiple such servers. Location-based services to be described herein in the context of a single server can be extended in a straightforward manner to accommodate multiple servers.

FIG. 1B shows one possible implementation of a given processing device of the system 100, which may represent one of the mobile user devices 102 or the LBS server 106. The processing device comprises a processor 110 coupled to a memory 112. The processor 110 is also coupled to a network interface 114 through which the processing device communicates with the wireless network 104.

Techniques for generating alerts based on learned patterns of movement and associated multidimensional fences can be implemented at least in part in the form of software stored in memory 112 and executed by processor 110. The memory 112 is one example of what is more generally referred to herein as a processor-readable storage medium containing executable program code.

The processor 110 may comprise, for example, a microprocessor, a central processing unit (CPU), an application-specific integrated circuit (ASIC), or other type of digital data processor. The memory 112 may comprise, for example, random access memory (RAM), read-only memory (ROM), disk-based memory, or other types of storage elements, in any combination. The network interface 114 may comprise, for example, conventional transceiver circuitry configured in accordance with one or more of the above-noted standards.

It will be assumed for purposes of this illustrative embodiment that the LBS server 106 stores application-specific information such as a user database, fence information for each user, etc. It is further assumed that mobile-server interaction utilizes a wireless link provided by the wireless network 104.

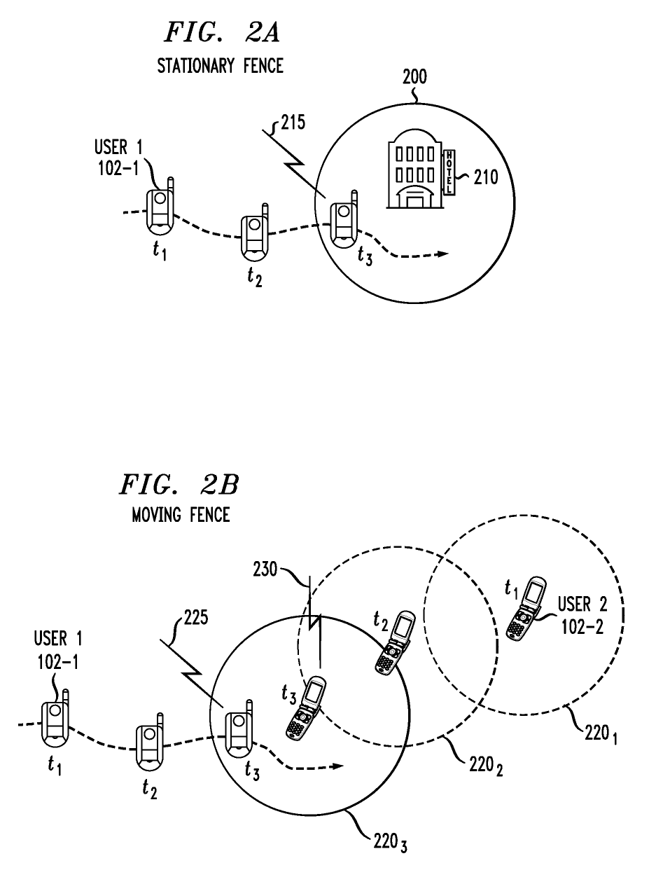

The fence information processed in system 100 may comprise stationary fences and moving fences, as will now be described with reference to FIGS. 2A and 2B. Stationary fences are fixed with respect to a particular geographic location, while moving fences move with a particular mobile user device. LBS applications that utilize fence-crossing information associated with moving or stationary fences are also referred to herein as “geofencing” applications.

FIG. 2A shows an example of a stationary fence 200 which comprises a circular boundary defined around a particular landmark 210. As indicated in the figure, a user denoted User 1 is associated with a particular mobile user device 102-1 and moves within the geographic area that includes the stationary fence 200. At times t₁ and t₂, the mobile user device 102-1 is outside the fence as indicated. At time t₃, the mobile user device 102-1 has crossed the fence 200 and a corresponding fence-crossing alert 215 is generated in the system 100.

FIG. 2B shows an example of a moving fence 220 which comprises a circular boundary defined around a particular user denoted User 2. User 2 is associated with mobile user device 102-2. The mobile user device 102-2 and its corresponding fence 220 move as indicated. Thus, the moving fence 220 is more particularly denoted by 220₁ at time t₁, 220₂ at time t₂ and 220₃ at time t₃. User 1 is also moving, again in a manner similar to that shown in FIG. 2A. At times t₁ and t₂, the mobile user device 102-1 is outside the moving fence 220 of User 2 as indicated. At time t₃, the mobile user device 102-1 has crossed the moving fence 220 of User 2 and corresponding fence-crossing alerts 225 and 230 are generated in the system 100.

It should be apparent from the examples of FIGS. 2A and 2B that stationary fences such as fence 200 require location tracking of individual users, while moving fences such as fence 220 require location tracking of pairs of users. Stationary fences are thus assigned to individual users, while moving fences are assigned to pairs of users. Although shown as circular in these examples, stationary and moving fences can have any number of other shapes or configurations, and may be open ended rather than closed. Also, fence-crossing alerts can be sent upon crossing a fence in either or both directions. Moving and stationary fences may also have finite lifetimes, that is, may be valid only for designated periods of time.

A stationary fence may be defined by information such as a geographic center location, a geographic boundary description with respect to the center location, a condition for generation of a crossing alert with respect to the geographic boundary, a start time, and an end time. A moving fence may be defined by information such as a geographic boundary description with respect to one location, a condition for generation of a crossing alert with respect to the geographic boundary, a start time, and an end time. Of course, other types of information may be used to define stationary and moving fences in other embodiments.

In the case of fence-crossing evaluation for moving fences, the geographic boundary is attached to the location of one of the users. Then fence-crossing conditions are evaluated with respect to the location of the other user for this boundary. This operation is symmetric with respect to the users of the user pair.

It is to be appreciated that numerous other types of fences can be used in a given embodiment of the invention. For example, moving fences need not relate to only a pair of users. Instead, a given moving fence may be implemented in the form of a star configuration connecting multiple users, with a center point of the configuration also moving. Numerous other alternative moving fence arrangements will be apparent to those skilled in the art.

Geofencing applications involving stationary or moving fences will typically require a variety of tasks to be performed in the system 100, such as location probing, location processing, evaluation of user location with respect to one or more fences, evaluation of fence-crossing conditions, forwarding of fence-crossing alerts, and fence processing, such as arrival of new fences, and expiration or cancellation of existing fences. In implementing such tasks, the system 100 in an illustrative embodiment may be configured to utilize a mobile-server communication protocol such as that described in commonly-assigned U.S. patent application Ser. No. 12/130,142, filed May 30, 2008 and entitled “Mobile-Server Protocol for Location-Based Services,” which is incorporated by reference herein. Use of such a protocol is beneficial in that it avoids overutilization of the air interface of the wireless network, particularly in high-volume geofencing applications.

It should be noted that the system 100 may be utilized to implement a wide variety of LBS applications, including both pull services and push services.

Pull services may involve, for example, requesting that location-relevant information be sent based on the geographic location of a trackee. The requester and the trackee can be the same person. The information can be forwarded to requester, trackee or a third party. More particular examples include a buddy locator which allows finding the location of a friend or child at a certain time. Another example is a directory service, where a user requests advertising or events taking place in his or her geographic vicinity.

Push services may involve, for example, forwarding location-relevant information when the trackee crosses a designated fence. Applied to the directory service, notices of local events may be sent to a user upon entering the zone where they take place. Another example is the child tracker, where parents are alerted when their child leaves a certain zone. Note that the alert can be sent to the trackee directly or via a third party (e.g., content provider) or it can solely be sent to a third party (e.g., parent in case of child tracker). Other push services may involve pairs of users, with alerts being provided based on the proximity between the two users. For example, an alert may be sent when the two users are within a certain predefined distance of one another. This type of alert can support friend-finder applications, for instance. It is also possible to send the alert when both users move away from each other beyond a predefined distance. This alert could support a child-tracking service application for a traveling parent. As indicated previously in conjunction with FIG. 2B, applications providing proximity alerts between user pairs are examples of geofencing applications, where the fence is attached to one user and the other user takes the function of the trackee.

Each of the stationary and moving fences illustrated in FIGS. 2A and 2B has a geographic area dimension. As will be described in detail below, such fences in embodiments of the present invention may be implemented as multidimensional fences that also include, in addition to the geographic area dimension, one or more additional dimensions such as a speed of movement dimension, a direction of movement dimension, a stop duration dimension, and a related device proximity dimension. These additional dimensions are determined for a given multidimensional fence from a normal pattern of movement of the corresponding mobile user device. Each dimension of the multidimensional fence has a corresponding parameter, and alerts may be generated if movement of the mobile user device deviates significantly from at least one dimension of the multidimensional fence.

For example, the speed of movement dimension may comprise a parameter specifying a speed of movement of the mobile user device within a geographic area defined by the geographic area dimension. Similarly, the direction of movement dimension may comprise a parameter specifying a direction of movement of the mobile user device within the geographic area defined by the geographic area dimension. The stop duration dimension may comprise a parameter specifying a particular duration of an expected stop at a given location within the geographic area defined by the geographic area dimension. The related device proximity dimension may comprise a parameter specifying that the given mobile user device either should or should not be in proximity to another mobile user device. Again, alerts may be generated if the movement of the given mobile user device deviates significantly from at least one of these dimension of the multidimensional fence.

The multidimensional fence may be further characterized by additional information. For example, the fence may be further characterized by at least one indicator specifying a time for which the dimensions of the multidimensional fence are valid. This may include a time of day indicator, a day of week indicator, a holiday flag, etc.

FIG. 3 shows an exemplary process for generating fence-crossing alerts in the system 100 of FIG. 1A using multidimensional fences. The process includes steps 300 through 308, which may be implemented in the LBS server 106.

In step 300, information indicative of current location of a given one of the mobile user devices 102 in the system 100 is periodically collected as the given mobile user device moves within the system. For example, mobile location may be probed at regular intervals by the wireless network 104 under the control of the server 106. Other known techniques for determining location of a mobile user device may be used. These known techniques may involve the use of Global Positioning System (GPS) or assisted GPS (aGPS) circuitry implemented in the mobile user device. Alternative embodiments can utilize other types of tracking techniques, including those based on RFID tags, infrared, ultrasound, etc.

In step 302, the collected location information is processed to determine a normal pattern of movement of the mobile user device. The normal pattern of movement generally characterizes the movement of the mobile user device from at least a first location to a second location within the system 100. This may involve predicting the normal pattern of movement based on movement of the mobile user device from the first location through one or more additional locations that do not include the second location.

A normal pattern of movement may be determined, for example, using the techniques described in PCT International Patent Application Publication No. WO2007145625, filed Jun. 14, 2006 in the name of inventors H. B. Meeuwissen and H. J. Batteram and entitled “Dynamic Route Prediction Based on Travel Patterns of Mobile Units,” which is commonly assigned herewith and incorporated by reference herein. Other suitable techniques for determining normal patterns of movement are described in N. Bila et al., “Mobile User Profile Acquisition Through Network Observables and Explicit User Queries,” Proceedings of the Ninth International Conference on Mobile Data Management, Beijing, China, pp. 98-107, IEEE, Apr. 27-30, 2008, and N. Bila et al., “Intuitive Network Applications: Learning User Context and Behavior,” Bell Labs Technical Journal, Vol. 13, Issue 2, pp. 31-47, August 2008, both of which are incorporated by reference herein.

The processing in step 302 may involve, for example, establishing an initial multidimensional fence for the mobile user device based on the normal pattern of movement, and periodically updating the multidimensional fence as the mobile user device continues to move within the system. Thus, several iterations of steps 300 and 302 may occur before the process moves to step 304.

In step 304, a determination is made as to whether or not subsequent movement of the mobile user device exhibits a significant deviation from the normal pattern of movement. The subsequent movement may be, for example, movement from the first location to the second location, or movement at least partway between these two locations. If the subsequent movement does not exhibit a significant deviation from the normal pattern of movement, the process returns to step 300 to collect additional location information. Otherwise, the process moves to step 306.

In step 306, a determination is made as to whether or not the observed deviation occurs in a parameter that has not been overridden by the user via the above-noted provisioning interface. As mentioned above, such parameters correspond to respective dimensions of a multidimensional fence. If the observed deviation occurs in a parameter that has been overridden by the user, the process returns to step 300 to collect additional location information. Otherwise, the process moves to step 308.

In step 308, an alert is generated within the system 100. As is apparent from the flow diagram, this alert is generated only if the movement of the mobile user device exhibits a significant deviation from the normal pattern of movement on one or more parameters that have not been overridden by the user.

The FIG. 3 process utilizes a learning approach in which LBS server 106 learns a normal pattern of movement of a given mobile user device 102 and adapts an associated multidimensional fence based on the learned normal pattern of movement. This overcomes the problems associated with the previously-described conventional unidimensional fences in which alerts are generated only when the boundary of the geographic area defined by the fence is crossed.

FIG. 4 shows an implementation of server 106 configured to generate multidimensional fences from learned patterns of movement in the system 100. The server 106 in this embodiment is accessible by a user 400 equipped with a device 402 which is a device other than the mobile user device 102-1, and is illustratively a personal computer. Mobile user device 102-1 is associated with a subscriber of the wireless network 104. The user 400 may be the subscriber or a different user of the system. The device 402 accesses the server 106 via a self-provisioning interface 404. The server 106 further includes a logger 410, a batch learning element 412, an interaction server 414, a user logs database 416, and a user profile database 418. The operation of the server 106 is illustrated in the figure by processing operations that are denoted as Steps 1 through 4.

In Step 1, the logger 410 obtains real-time user location information. Such information may be obtained, for example, by direct communication with the mobile user device, or by querying a network-based location server that obtains the location information directly from the mobile user device. Such a network-based location server may be part of the wireless network 104. The logger 410 stores the location information in the user logs database 416.

In Step 2, the batch learning element 412 periodically runs statistical algorithms on the location information logs of each user in order to generate summary information about his or her normal movement patterns within the system 100. As mentioned above, this step may involve use of the techniques disclosed in the above-cited PCT Publication No. WO2007145625. The learned information comprising the normal patterns of movement for various system users is stored in user profile database 418.

In Step 3, the interaction server 414 generates alarms, queries or other alerts if movement of the user device 102-1 deviates from the normal pattern of movement previously determined for the corresponding system user. Thus, in this embodiment, alerts are generated if the user device movement deviates from at least one of the parameters that correspond to respective dimensions of the multidimensional fence established from the normal pattern of movement. Although the figure illustrates the provision of alarms, queries or other alerts from the server 106 to the mobile user device 102-1, such alerts could also or alternatively be provided by the server to the user 400.

In Step 4, the user 400 utilizes device 402 to access the server 106 via the self-provisioning interface 404. The multidimensional fence determined based on the learned normal pattern of behavior is presented to the user and the user is permitted to override or otherwise update one or more of its parameters, such as parameters associated with one or more of the previously-described speed of movement, direction of movement, stop duration and related device proximity dimensions. The overrides entered by the user may include, for example, temporary overrides that expire after a specified period of time. Alternatively, one or more overrides may be permanent overrides.

A specific example of the operation of the LBS server 106 of FIG. 4 in implementing a child-tracking service will now be described. Assume that the user associated with mobile user device 102-1 is a child that attends school and the user 400 associated with device 402 is a parent of that child. A normal pattern of movement for this user and his associated mobile user device may be as follows: On every Tuesday that is not a school holiday, over the period from 3 PM to 3:30 PM, the user is in transition between school and the town library for an after-school activity. He is expected to be walking. He may stop on his way at a convenience store that is at the corner of the first two streets that he passes.

The batch learning element 412 of server 106 can learn this normal pattern of movement by processing location information periodically collected by the logger 410. The normal pattern of movement may be characterized by information such as day of the week, time of the day, a flag indicating whether or not the day is a school holiday, starting location X of the school, destination location Y of the town library, a path between X and Y that includes designated streets, intermediate location Z of the convenience store, and a speed of movement of between 0 and 4 miles per hour.

In order to learn such a pattern of movement, the logger 410 collects location information over a period of time, which in the present example may be on the order of several weeks. This information is analyzed by partitioning it into different groups for day of week, time of day, holiday versus non-holiday, and so on. Frequented locations may be identified by automatic clustering. Commonly followed trajectories between the frequented locations are identified. The identified locations and trajectories may then be associated with known locations (e.g., school, store, town library) and known paths (e.g., streets) on a map. Maximum, minimum and average expected duration of stay at each location may be determined, as well as the maximum, minimum and average expected speed on each path.

A multidimensional fence is created from the learned normal pattern of movement. This fence may have dimensions associated with geographic area, speed of movement, direction of movement, and stop duration. Probabilistic models (e.g., a Gaussian distribution) may be specified for the respective normal ranges of these dimensions (e.g., geographic area, speed, direction, stop duration). The multidimensional fence may further include deterministic values as indicators for each of the discrete variables, such as days of the week, times of the day, and holiday flag, etc.

The multidimensional fence is used to control the generation of alerts. For example, an alarm, query or other type of alert may be presented to the parent at device 402 via the interface 404 of the server 106 if the mobile user device 102-1 is determined to exhibit a significant deviation from its normal pattern of movement. This may occur if at the specified day of the week and time of day, when it is not a school holiday, the mobile user device is not within a specified distance of locations X, Y or Z, is not moving in an expected direction on one of the designated streets, is moving faster than the expected speed (e.g., possibly riding a car), or exhibits a longer than expected delay at a particular location (e.g., stops at a location other than X, Y or Z and does not move for over 20 minutes).

The system 100 having server 106 configured as shown in FIG. 4 thus learns the normal pattern of movement of a given mobile user device 102-1 by analyzing its location over time. The learning process may correlate information about travel speeds, routes, destinations, arrival times, modes of transportation, time (e.g., time of day, day of week, etc.), proximity of other known mobile devices, additional map data (e.g., location of roads, railroads, etc.), and frequented locations. This information can be used to determine, in whole or in part, the multidimensional fence to be applied by various location-based service applications. The corresponding fence area is therefore not unidimensional, but is instead variable within a multidimensional space (e.g., incorporating additional dimensions for speed of movement, direction of movement, stop duration and related device proximity). A given location-based service application uses this multidimensional fence to provide services that are better targeted to the needs of its users.

As mentioned previously, the server 106 may present the parameters of a given multidimensional fence to a user for confirmation prior to utilizing that fence in the generation of alerts. User responses to such a presentation, as well as user responses to any alerts generated using a confirmed fence, can be used to enhance the learning process. For example, the system may alert a parent that his or her child had left a particular geofenced area, and the parent may reply that the detected location outside of the geofenced area is actually an acceptable one for the child. The system would record all pertinent information associated with the detected significant deviation, such as location, date, time, speed of movement, direction of movement, and any other mobile user devices in the vicinity of the child. After several user responses to alarms, the system aims to identify patterns in those acceptable situations, and either expands the fence parameters accordingly or prompts the user for permission to expand the fence parameters. For example, the previously-described multidimensional fence for a child-tracking service may be modified to incorporate additional parameters such as “when the child is at a specific address between 3:30 PM and 6:00 PM,” or “when the child is near grandpa.”

A given embodiment of the invention may configure interface 402 or another user interface to allow a user to specify a particular combination of parameters for a multidimensional fence using standard predetermined templates.

The above-described techniques involving use of multidimensional fences generated from learned normal patterns of movement provide considerable advantages over conventional techniques that utilize unidimensional fences. For example, in a conventional child-tracking service with unidimensional fences, a parent could specify permitted geographic areas (e.g., home, school, and mall), but would not be able to determine if the child is walking in the permitted areas after school or riding in a car through those areas during school hours. The child-tracking service using multidimensional fences as described above clearly provides more useful monitoring of the current location of the child.

Again, it is to be appreciated that the particular system elements, process operations and other features of the illustrative embodiments described above are presented by way of example only. As indicated previously, the above-described techniques can be adapted in a straightforward manner for use in other types of wireless communication systems and with other types of location-based services. In addition, the invention can be applied to sub-networks or other designated portions of a given wireless network, or to combinations of multiple wireless networks or other networks of potentially differing types. Also, the particular techniques used to determine normal patterns of movement and the associated multidimensional fences generated from the normal patterns of movement may be varied in other embodiments. These and numerous other alternative embodiments within the scope of the appended claims will be readily apparent to those skilled in the art.

We claim:

1. A method comprising the steps of:
periodically collecting information indicative of location of a mobile user device of a communication system;
processing the collected location information in a processing device of the communication system to determine at least one normal pattern of movement of the mobile user device from at least a first location to a second location; and
generating an alert if subsequent movement of the mobile user device from the first location to the second location exhibits a significant deviation from the normal pattern of movement.

2. The method of claim 1 wherein said processing device comprises a server of the communication system.

3. The method of claim 1 wherein the processing step further comprises generating a multidimensional fence based on the normal pattern of movement of the mobile user device.

4. The method of claim 3 wherein the step of generating an alert comprises generating the alert if the subsequent movement of the mobile user device deviates from at least one dimension of the multidimensional fence.

5. The method of claim 3 wherein said multidimensional fence includes at least a geographic area dimension and at least one of:
a speed of movement dimension;
a direction of movement dimension;
a stop duration dimension; and
a related device proximity dimension.

6. The method of claim 5 wherein the speed of movement dimension comprises a parameter specifying a speed of movement of the mobile user device within a geographic area defined by the geographic area dimension.

7. The method of claim 5 wherein the direction of movement dimension comprises a parameter specifying a direction of movement of the mobile user device within a geographic area defined by the geographic area dimension.

8. The method of claim 5 wherein the stop duration dimension comprises a parameter specifying a particular duration of an expected stop at a given location within a geographic area defined by the geographic area dimension.

9. The method of claim 5 wherein the related device proximity dimension comprises a parameter specifying that the mobile user device either should or should not be in proximity to another mobile user device within a geographic area defined by the geographic area dimension.

10. The method of claim 5 wherein the multidimensional fence is further characterized by at least one indicator specifying a time for which the dimensions of the multidimensional fence are valid.

11. The method of claim 1 wherein the processing step further comprises predicting the normal pattern of movement based on movement of the mobile user device from the first location through one or more additional locations that do not include the second location.

12. The method of claim 1 wherein the processing step further comprises the steps of:
establishing an initial multidimensional fence for the mobile user device based on the normal pattern of movement; and
periodically updating the multidimensional fence as the mobile user device moves within the system.

13. The method of claim 3 further comprising the steps of:
presenting the multidimensional fence to a user of the mobile device; and
permitting the user to at least temporarily override parameters specifying respective dimensions of said multidimensional fence such that an alert will not be generated if the significant deviation is a deviation in only said at least one parameter overridden by the user.

14. A processor-readable storage medium containing executable program code that when executed by a processor implements the steps of claim 1.

15. An apparatus comprising:
a processing device having a processor coupled to a memory;
wherein the processing device is configured to process periodically collected information, indicative of location of a mobile user device of a communication system, to determine at least one normal pattern of movement of the mobile user device from at least a first location to a second location; and
wherein an alert is generated if subsequent movement of the mobile user device from the first location to the second location exhibits a significant deviation from the normal pattern of movement.

16. The apparatus of claim 15 wherein the processing device comprises a server of the communication system.

17. The apparatus of claim 15 wherein the processing device is further operative to generate a multidimensional fence based on the normal pattern of movement of the mobile user device and generates the alert if the subsequent movement of the mobile user device deviates from at least one dimension of the multidimensional fence.

18. The apparatus of claim 17 wherein the processing device comprises a provisioning interface that presents the multidimensional fence to a user of the mobile device and permits the user to override parameters specifying respective dimensions of said multidimensional fence such that an alert will not be generated if the significant deviation is a deviation in only said at least one parameter overridden by the user.

19. The apparatus of claim 18 wherein the provisioning interface is accessible to the user via a device other than the mobile user device.

20. A communication system comprising:
a plurality of mobile user devices configured to communicate over a wireless network; and
a processing device coupled to the wireless network;
wherein the processing device is configured to process periodically collected information, indicative of location of at least a given one of the mobile user devices, to determine at least one normal pattern of movement of the given mobile user device from at least a first location to a second location; and
wherein an alert is generated if subsequent movement of the given mobile user device from the first location to the second location exhibits a significant deviation from the normal pattern of movement.
